(19) United States
(12) Patent Application Publication
(10) Pub. No.: US 2015/0235025 A1
(43) Pub. Date: Aug. 20, 2015

(54) PROCESS TO PREVENT MALICIOUS CHANGES TO ELECTRONIC FILES ON AN ELECTRONIC STORAGE DEVICE

(71) Applicant: Mark Mundy, Tomball, TX (US)

(72) Inventor: Mark Mundy, Tomball, TX (US)

(21) Appl. No.: 14/627,857

(22) Filed: Feb. 20, 2015

Related U.S. Application Data
(60) Provisional application No. 61/942,379, filed on Feb. 20, 2014.

(51) Int. Cl. G06F 21/56

(52) U.S. Cl. CPC G06F 21/565; G06F 2221/033

(57) ABSTRACT

Provided herein is a method for detecting significant changes to files on an electronic storage device, determining if those changes meet a configurable threshold to be considered significant changes, and take actions by or on behalf of the user to accept or decline the changes before they are committed to the system.

### BACKGROUND OF THE INVENTION

Advances in computer crimes have resulted in the development of a new class of computer virus referred to a “ransomware”. When a computer is infected by this type of virus, the virus will encrypt many or all of the files, leaving only the files necessary to boot to the operating system. The user will be notified at some point that the only method for retrieving their files is to pay a ransom for the decryption key. Typically the cyber-criminal provides instructions to the user to pay a ransom through an untraceable account held by the cyber-criminal. If the user does not pay the ransom within some set period of time (frequently 72 hours), the cyber-criminal will dispose of the key, and the information stored in the encrypted files will be essentially lost forever.

While virus scanning software exists to identify viruses by particular code signatures, new viruses are being invented constantly. The viruses have to be analyzed by specialists employed in each of the many software companies which supply anti-virus software. The specialists identify unique code or data structures in the virus program, and then create new signature data files which are disseminated around the world to their customers. This process takes some amount of time, and, during this period, millions of computers may be exposed and infected.

With the ever-widening network of computing devices of all types, cyber-criminals are finding ways to introduce this type of virus beyond personal computers to networked computers, network storage devices, smart phones, Internet-enabled tablet devices, and any other electronic device that stores electronic files.

### BRIEF DESCRIPTION OF THE DRAWINGS

FIG. 1 is a flowchart showing a request to access a data file on a computing device via operating system calls, in accordance with an exemplary embodiment of the invention.

FIG. 2 is a flowchart showing the process of completing an access to a data file, in accordance with an exemplary embodiment of the invention.

### DETAILED DESCRIPTION

### Preferred Embodiment

The process described by this disclosure protects the files on an infected computer from experiencing significant losses from this class of virus.

As used herein, the terms “electronic data file”, “electronic data” and “file” are to be used interchangeably and refer to any unit of electronic information used by an electronic device which represents information used by the device to form executable code or data used by executable code organized in any format recognized by the electronic device or the executing applications operating within.

As used herein, the terms “electronic device”, “computing device”, “device”, “computing device”, and “computer” are to be used interchangeably and refer to any one of various smartphones, personal digital assistants (PDAs), tablet computers, laptops, personal computers, servers and other similar electronic devices that include a processor, an operating system operating either as hardware, software, or firmware which provides to executing applications a method for opening, reading, and writing information to an electronic storage device.

As used herein, “electronic storage device”, “storage device”, “storage media” are to be used interchangeably and refer to any transitory or non-transitory machine-readable systems contained inside the device, connected directly to the device, or contained within another device in an external or remote location which the device is able to communicate with which is capable of storing machine-readable data, and may consist of, but is not limited to, any method by which the storage device maintains electronic data either in a transitory or volatile state, which is lost if the electronic storage device is disconnected from its power supply, or in a non-transitory or nonvolatile state, which is maintained even when the electronic storage device is disconnected from its power supply. Examples of volatile storage devices include, but are not limited to, Random Access Memory (RAM), CPU cache, or motherboard cache. Examples of nonvolatile storage devices include, but are not limited to, Hard Disk Drives (HDD), Solid State Drives (SSD), magnetic tapes, optical disks (CDs, DVDs, Blu-Ray Disks, etc.), Secure Disk cards (SD cards), or network storage devices and Storage Area Networks (SAN).

As used herein, the terms “executing application”, “application” and “program” are to be used interchangeably, and refer to any software, hardware, or firmware process executing on an electronic device to perform specific tasks within the operating system of the device or which utilizes processes within the operating system which may interact with and respond directly to user input, operating system tasks, background services or daemons running special processes, or firmware embedded processes. Examples include, but are not limited to, word processing and other business applications, database applications, calculation engines, programming tools, web browser and web applications, gaming applications, even malicious applications such as viruses and worms.

As used herein, the term “operating system” or “OS” refers to a special class of software that provides a common method for applications to access hardware and software resources of the device, including but not limited to allocating memory, interacting with the user through keyboard, mouse, touch screens, or proximity devices, accessing networking hardware or software to communicate with other devices, or organizing the files on a storage device and providing a common structure for applications to access the files.

As used herein, an “Operating System Disk I/O Manager” is a portion of specialized applications within the Operating System which interacts directly with a device driver according to specifications defined by the Operating System author to communicate with a storage device from any of several manufacturers to open, read from, write to, and close files on the storage device on behalf of the Operating System.

As used herein, a “device driver” is a specialized application provided by the manufacturer of a storage device that provides an interface for the Operating System to interact with the storage device to open, read from, write to, and close files on behalf of the Operating System.

As used herein, a “File System Filter” refers to, but is not limited to, a portion of the Operating System Disk I/O Manager, device driver, or storage device, whether executing as software, hardware, or firmware which allows specialized computing commands to be performed beyond the normal interaction between the Operating System and the device driver for the storage device.

As used herein, a “request” refers to a command issued by an Executing Application to access a data file on an electronic storage device, and contains, but is not limited to information regarding the file to be accessed, the command to perform on the file, and additional information necessary to carry out the command on the file.

As used herein, a “file handle” refers to any identifier or combination of identifiers used by the Operating System, Operating System Disk I/O Manager, File System Filter, device driver, application, storage device, or other software, hardware, or firmware that comprises the device or combination of devices that uniquely identifies a file within the device or combination of devices.

As used herein, the terms “shadow copy” or “temporary copy” are to be used interchangeably and refer to the use of a full copy, a portion of, or a mapping of data within a file stored in volatile or non-volatile storage for the purposes of identifying changes to original files prior committing the changes to non-volatile storage.

As used herein, the term “significant changes” refers to one or more changes to a file that meets a change level criteria between a version of an electronic file and the version which is being actively changed or committed to a non-volatile storage device for which an action should be taken by or on behalf of the user.

During the typical operation of a computing device, many applications are executing and performing operations at the same time. When any of these Executing Applications (1) requires the opening of an electronic data file on the internal, external, or remotely connected storage media, it does not perform this operation directly. Rather, it makes requests of the Operating System to interact with the Operating System Disk I/O Manager (2) and the Device Driver Access to Storage (5) to retrieve information, change contents, and commit any changes to data files on the physical storage device.

The Executing Application (1) uses a standardized library of file input/output (I/O) functions to request the opening of an electronic data file, reading and writing data from and to the file, and eventually closing the file, committing any changes made. The library of file I/O functions makes specific requests on behalf of the application through the Operating System Disk I/O Manager (2) to manage the layers of abstraction between the application, the Operating System (OS), the device drivers, and the physical devices where the files are stored whether as part of the device or remotely. Due to this abstraction, the design of modern computers allows the Executing Application (1) to be unaware of the actual hardware of the storage device, but still able to communicate with it to access files.

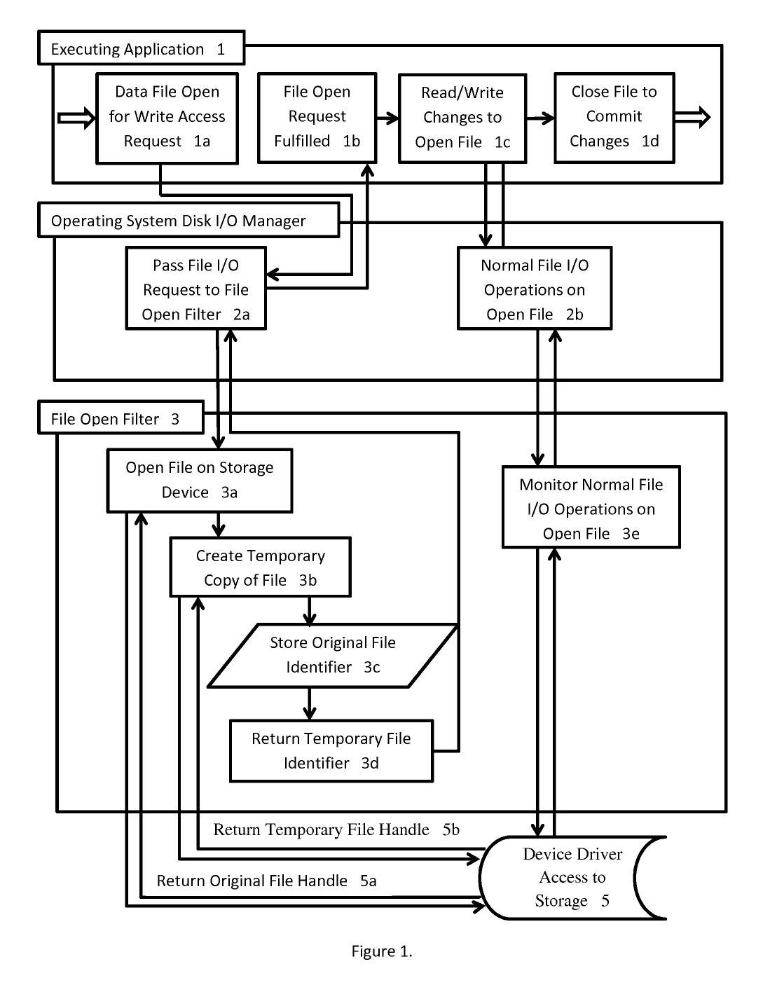

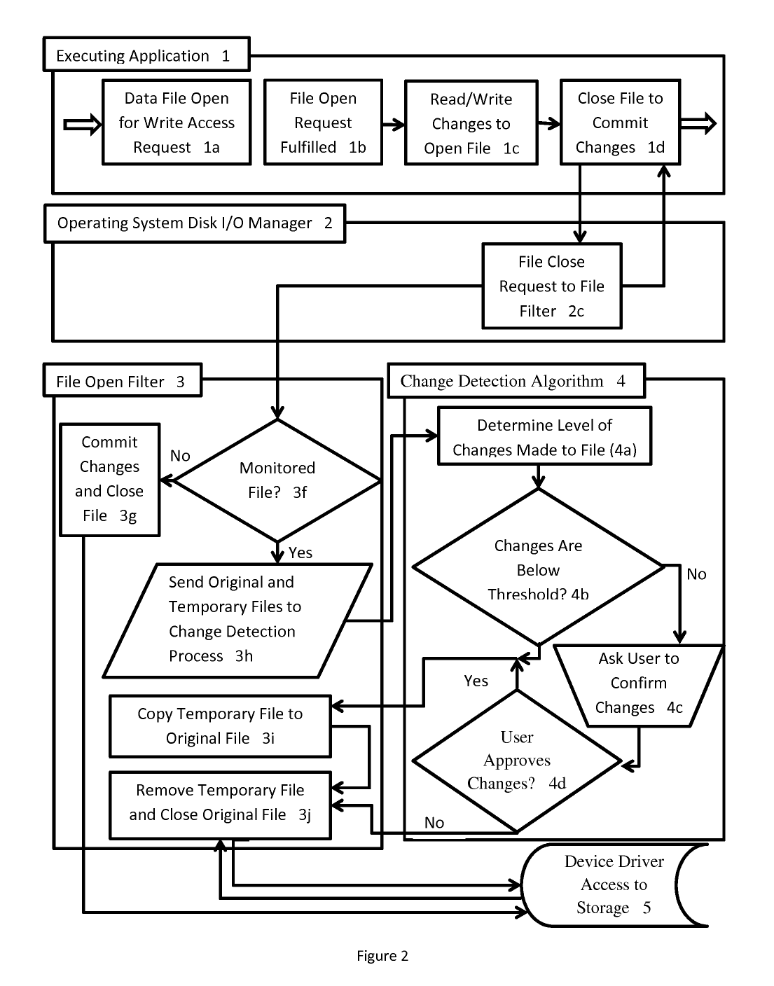

FIGS. 1 and 2 demonstrate the logic flow of one preferred embodiment of the process subject of this invention through the stages of the initial file open request state and read/write operations state performed by and on behalf of the Executing Application (1). The state “Data File Open for Write Access” (1a) occurs when the Executing Application (1) reaches a point in its execution when it needs to interact with and make changes to a data file. The request to open the file is created through a call through the standardized File I/O functions (not shown) to the Operating System Disk I/O Manager (2). The Executing Application (1) will wait for the Operating System Disk I/O Manager to return a file identifier which changes the state of the process identified by “Data File Open for Write Access” (1a) to the state identified by “File Open Request Fulfilled” (1b) before the Executing Application (1) will continue its operation.

The Operating System Disk I/O Manager (2) is a component of the computer's operating system that monitors and channels all file input/output operations requested by any of many Executing Applications to the actual storage device. When a request for interaction with a file is made, the Operating System Disk I/O Manager will enter the state indicated by “Pass File I/O Request to File Open Filter” (2a) to satisfy the file input/out request and wait for the File System Driver or Device Driver to fulfill the request.

As an extension of the Operating System Disk I/O Manager, the File Open Filter (3) of the preferred embodiment monitors file open requests from any Executing Application (1) which attempts to open a file with privilege to write permanent changes to the file. File open requests for read only access privileges may be ignored in the preferred embodiment or other commands may be performed. Information is collected and stored in volatile or non-volatile storage by the File Open Filter (3) and this information will allow the File Open Filter (3) to perform additional commands on the file or other file requests at times in the future. The state “File Open on Storage Device” (3a) is entered when the request is forwarded on to device driver. When the device driver receives the request, the state “Device Driver Access to Storage” (5) is entered.

The process state returns to Open File on Storage Device (3a) when a valid unique file identifier is returned by the device driver to fulfill the request to open the file on the storage device. This is the normal response if the File Open Filter (3) and process described in this application was not in place. After the file identifier is returned, the File Open Filter (3) will change state to Create Temporary Copy of File (3b).

The File System Filter (3) will combine the information received in the file open request of state Open File on Storage Device (3a) with the file handle returned by passing the request to state Device Driver Access to Storage (5) and create a shadow copy of the file. The shadow copy of the file will appear identical to the actual file to the Executing Application (1). The File Open Filter (3) maintains a record of the requests and file handles that have been opened through the process and their corresponding temporary shadow files. The File Open Filter (3) will Store Original File Identifier (3c) with this information in a data structure for later use. The process state will change to Return Temporary File Identifier (3d) as the File System Filter (3) a file identifier to the Operating System Disk I/O manager (2) and the Executing Application (1) state changes to File Open Request Fulfilled (1b). The Executing Application (1) does not know that it is working with a shadow copy rather than the originally requested file.

During the time the Executing Application (1) has the file opened, it will perform one or many read or write transactions on that file through calls to the standardized File I/O functions (not shown) and through the Operating System Disk I/O Manager (2) as part of its normal operations prior to closing the file all of which will pass through the Normal File I/O Operations on Open File (2b). Monitor Normal File I/O Operations on Open File (3e), and Device Driver Access to Storage (5), then return back through these states repeatedly until the Executing Application (1) reaches the state in its operation when it can Close File to Commit Changes (1d). The Executing Application (1) is not aware of the fact that it is making changes to a copy of the file it requested. All file input/output requests it makes are fulfilled through the Operating System Disk I/O Manager (2) as normal.

FIG. 2 demonstrates the logic flow state when the Executing Application (1) is ready to Close File to Commit Changes (1d) because it has finished making changes to the open file. The close request is performed through a call to the standardized File I/O functions (not shown) to the Operating System Disk I/O Manager (2). All file close requests pass through the File Close Request to File Filter (2c) and passed to the File Open Filter (3) where a conditional action is taken to determine if the request is for a Monitored File (3f).

If the file is not monitored by the process subject of this disclosure, then the Commit Changes and Close File (3g) state will occur by forwarding the request to the Device Driver Access to Storage (5). The process completes when the Close File to Commit Changes (1d) state completes within the Executing Application (1) receives a completion acknowledgment from the Operating System I/O Manager (2).

If the file is monitored by the process subject of this disclosure, then the File System Filter (3) will enter the state Send Original and Temporary Files to Change Detection Process (3h) which transfers the information on the open file and the temporary shadow file collected during the File Open on Storage Device (3a), Create Temporary Copy of File (3b), and Store Original File Identifier (3c) states to the Change Detection Algorithm (4). Exemplary embodiments include copying all contents of the original file to the temporary file prior to entering Return Temporary File Identifier (3d) state or during the Monitor Normal File I/O Operations on Open File (3e) state provide additional ability to retrieve data for the Executing Application (1) file operations on at the time requested with data from the original file only as necessary to fulfill the immediate request.

The Change Detection Algorithm (4) will use the information provided by the File System Filter (3) to Determine Level of Changes Made to File (4a) state. Exemplary embodiments to determine the magnitude of changes include counting the changes to the file on a byte by byte basis or scanning both the original and temporary files for identical sections and calculating a percentage of the overall file data which the percentage represents. Using one or many methods the Change Detection Algorithm (4) will determine if the Changes Are Below Threshold (4b). If the differences between the original file and changed version of the file meet the change criteria level for that file, the Change Detection Algorithm (4) will Copy Temporary File to Original File (3i) then it will Remove Temporary File and Close Original File (3j). Exemplary embodiments include comparing the byte by byte count of changes, percentage changes, or other magnitude calculated by the Determine Level of Changes Made (4a) state and comparing them to a threshold set by or on behalf of the user.

Using one or many methods the Change Detection Algorithm (4) will determine if the differences between the original file and the changed version of the file meet the change criteria level for that file, file type, or other classification determined by or on behalf of the user, the process state changes to Ask User to Confirm Changes (4c) where actions (not shown) are taken by or on behalf of the user to accept or decline the changes. If the user accepts the changes, the Change Detection Algorithm (4) will enter state Copy Temporary File to Original File (3i) then enter Remove Temporary File and Close Original File (3j) state to perform the necessary operations. If the user does not accept the changes through direct action or through actions taken on their behalf, the Change Detection Algorithm (4) will enter the Remove Temporary File and Close Original File (3j) state and close the original file without allowing the changes to be committed to the storage device.

An Executing Application should not be blocked from performing its tasks in an efficient manner, and should never have any awareness of the fact it is not modifying any specific file it requests. Exemplary embodiments to achieve this requirement include copying the full contents of the original file to the temporary copy or filling the temporary file with only the requested data at the time it is requested by the Executing Application (1). An important consideration in the operation of the invention subject to this disclosure is the speed with which the process completes so any Executing Application (1) performs as required.

To improve performance of the invention, an alternate embodiment may be implemented to actively Monitor Normal File I/O Operations on Open File (3e) through continuous monitoring of changes and alert the user of significant changes prior to the actual closing of the file. This method would be useful on files that remain open for significant periods of time, files that are very large, or files stored on storage devices that are not inside the actual electronic device.

Many options exist to alert the user of changes that meet the criteria to be considered significant changes. A direct message the user, requiring immediate attention, an event registered in a log file that must be cleared before the process will close the open files, tools for analysis of the changes, storage of both the temporary and the original files for later analysis, as well as other methods may be employed.

Many options exist to allow or decline changes that meet the criteria to be considered significant changes to be made on behalf of the user when significant changes are detected. These may include preconfigured actions set by the user, an administrator of the electronic device or storage device, or a central authority who makes such decisions.

One skilled in the art will appreciate that the File Open Filter (2) may be embedded and configured at multiple levels of the computing system to control operations of the system resulting in an increased security to the entire system, limited applications, limited users, or specific files. One skilled in the art would appreciate that implementations of the innovation in the firmware of storage devices would alleviate traffic associated with the innovation to other areas of the device, and may yield more desirable results in many embodiments.

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory (such as memory of the handheld portable electronic device) and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A non-transitory machine-readable storage medium encoded with instructions executable by at least one processing device of an electronic device, the machine-readable storage medium comprising instructions to:
maintain one or many records required to uniquely identify one or many organizations of electronic data stored on non-transitory storage medium;
detect modifications to information to be stored on non-transitory machine-readable storage medium made by one or many processes executing within one or many electronic devices prior to committing changes;
identify the magnitude of said modifications to information to be stored on non-transitory storage medium through one or many mathematical algorithms;
determine if the magnitude of said modifications meets one or many criteria to prevent committing said modifications on non-transitory storage medium without intervention;
provide one or many methods of intervention which may be performed by or on behalf of the user of the electronic device prior to committing said modifications to non-transitory machine readable storage.

2. The system of claim 1, configured to maintain one or many records required to uniquely identify organizations of electronic data stored on non-transitory storage medium performed as encoded instructions executable by at least one processing device of an electronic device.

3. The system of claim 1, configured to detect modifications to be stored on non-transitory machine-readable storage medium performed as encoded instructions executable by at least one processing device of an electronic device.

4. The system of claim 1, configured to identify modifications to be stored on non-transitory machine-readable storage medium performed as encoded instructions executable by at least one processing device of an electronic device.

5. The system of claim 1, configured to determine the magnitude of modifications to be stored on non-transitory machine-readable storage medium performed as encoded instructions executable by at least one processing device of an electronic device.

6. The system of claim 1, configured to enable interventions by the user of the electronic device performed as encoded instructions executable by at least one processing device of an electronic device.

7. The system of claim 1, configured to enable interventions on behalf of the user of the electronic device performed as encoded instructions executable by at least one processing device of an electronic device.

8. The system of claim 1, configured to maintain one or many records required to uniquely identify organizations of electronic data stored on non-transitory storage medium performed as encoded instructions executable by at least one processing device of an electronic storage device.

9. The system of claim 1, configured to detect modifications to be stored on non-transitory machine-readable storage medium performed as encoded instructions executable by at least one processing device of an electronic storage device.

10. The system of claim 1, configured to identify modifications to be stored on non-transitory machine-readable storage medium performed as encoded instructions executable by at least one processing device of an electronic storage device.

11. The system of claim 1, configured to determine the magnitude of modifications to be stored on non-transitory machine-readable storage medium performed as encoded instructions executable by at least one processing device of an electronic storage device.

12. The system of claim 1, configured to enable interventions by the user of the electronic device performed as encoded instructions executable by at least one processing device of an electronic storage device.

13. The system of claim 1, configured to enable interventions on behalf of the user of the electronic device performed as encoded instructions executable by at least one processing device of an electronic storage device.

14. The system of claim 1, configured to maintain one or many records required to uniquely identify organizations of electronic data stored on non-transitory storage medium performed as encoded instructions executable by at least one processing device of an electronic communication device.

15. The system of claim 1, configured to detect modifications to be stored on non-transitory machine-readable storage medium performed as encoded instructions executable by at least one processing device of an electronic communication device.

16. The system of claim 1, configured to identify modifications to be stored on non-transitory machine-readable storage medium performed as encoded instructions executable by at least one processing device of an electronic communication device.

17. The system of claim 1, configured to determine the magnitude of modifications to be stored on non-transitory machine-readable storage medium performed as encoded instructions executable by at least one processing device of an electronic communication device.

18. The system of claim 1, configured to enable interventions by the user of the electronic device performed as encoded instructions executable by at least one processing device of an electronic communication device.

19. The system of claim 1, configured to enable interventions on behalf of the user of the electronic device performed as encoded instructions executable by at least one processing device of an electronic communication device.
